(19) United States
(12) Patent Application Publication
(10) Pub. No.: US 2009/0071800 A1
(43) Pub. Date: Mar. 19, 2009

(54) Wheel feeder

(75) Inventor: Tae Yong Kim, Seoul (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 12/005,795

(22) Filed: Dec. 28, 2007

(30) Foreign Application Priority Data
Sep. 19, 2007 (KR) 10-2007-0095405

(51) Int. Cl. B65G 47/34

(52) U.S. Cl. 198/463.3

(57) ABSTRACT

A wheel feeder for supplying a wheel to a wheel mounting factory is disclosed. The wheel feeder includes: a vertical lifter for receiving a wheel transferred from a transferring conveyor; a vertical conveyor for receiving the wheel from the vertical lifter and transferring the wheel to a wheel mounting factory; and a wheel stopper unit mounted to the vertical lifter to supply the wheel to the vertical conveyor without damaging the wheel.

### CROSS-REFERENCE TO RELATED APPLICATION

This application claims the benefit under 35 U.S.C. §119(a) on Korean Patent Application No. 10-2007-0095405 filed on Sep. 19, 2007, the entire contents of which are incorporated herein by reference.

### BACKGROUND

1. Technical Field

The present invention relates to a wheel feeder, and more particularly, to a wheel feeder in which a wheel stopper unit is installed in a vertical lifter.

2. Background Art

FIG. 1 shows an operation of a wheel feeder according to a conventional art. The conventional wheel feeder of FIG. 1 comprises a transferring conveyor 1 for transferring a wheel 2, a vertical conveyor 5 for supplying the wheel transferred from the transferring conveyor 1 to a wheel mounting factory (not shown) arranged therebelow, and a conveying rail 3 installed between the transferring conveyor 1 and the vertical conveyor 5 to convey the wheel 2 from the transferring conveyor 1 to the vertical conveyor 5.

A guide rail 6 for receiving the wheel 2 from the conveying rail 3 is inclinedly installed in one side of the vertical conveyor 5, and the vertical conveyor 5 has a wheel guide bar 5a on which the wheel 2 supplied from the guide rail 6 is rested.

A seesaw stopper 4 for guiding the wheel 2 to the wheel guide bar 5a from the guide rail 6 is installed between the guide rail 6 and the wheel guide bar 5a.

An operation of the conventional wheel feeder is described below.

The wheel 2 transferred by the transferring conveyor 1 is rested onto the conveying rail 3, and one side of the conveying rail 3 is raised so that the conveying rail 3 gets inclined at the same angle as the guide rail 6 which inclines to the vertical conveyor 5. The wheel 2 is transferred along the conveying rail 3 and the guide rail 6 which are inclined and is guided by the seesaw stopper 4 to be rested onto the wheel guide bar 5a formed in the vertical conveyor 5.

When the wheel is rested on the wheel guide bar 5a, the vertical conveyor 5 rotates to supply the wheel to the wheel mounting factory (not shown) located below the vertical conveyor 5.

However, due to an impact generated during the process for transferring the wheel from the conveying rail to the vertical conveyor, a frame and a tire of the wheel may get damaged, and the guide rail 6, the seesaw stopper 4 and the wheel guide 5a which are arranged in the vertical conveyor 5 bar may get damaged.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the aforementioned problems associated with prior arts and one primary object of the present invention is to provide a wheel feeder which can feed a wheel without damaging a frame and a tire.

In one aspect, the present invention provides a wheel feeder for supplying a wheel to a wheel mounting factory, comprising: a vertical lifter for receiving a wheel transferred from a transferring conveyor; a vertical conveyor for receiving the wheel from the vertical lifter and transferring the wheel to a wheel mounting factory; and a wheel stopper unit mounted to the vertical lifter to supply the wheel to the vertical conveyor without damaging the wheel.

In a preferred embodiment, the wheel stopper unit comprises a seesaw stopper on which the wheel transferred from the transferring conveyor is firstly rested and a stop arm on which the wheel supplied from the seesaw stopper is secondly rested.

Preferably, in the embodiment, the seesaw stopper is provided with a sensor for detecting position of the transferred wheel such that when the wheel is detected to be rested on the seesaw stopper, the seesaw stopper can be moved in an upper direction of the vertical lifter.

Also preferably, in the embodiment, the stop arm comprises a resting portion on which the wheel supplied from the seesaw stopper is rested, a link portion which is hinge-coupled to the resting portion to rotate the resting portion in order to supply the wheel rested on the resting portion onto the vertical conveyor, and a cylinder portion for operating the link portion.

Suitably, the link portion is provided with a sensor for detecting rotation direction of the wheel such that when the rotation direction is detected to be in a predetermined range, the speed of the stop arm can be reduced for the wheel rested on the resting portion of the stop arm to be rested onto the wheel guide bar at a low speed. Also suitably, the cylinder portion is supported by a bracket installed in the vertical lifter. Further suitably, one side of the link portion is hinge-coupled to the bracket.

In another preferred embodiment, a wheel guide bar on which the wheel supplied from the stop arm is rested is formed in the vertical conveyor in a direction crossing a longitudinal direction of the vertical conveyor.

Other aspects of the invention are discussed infra.

### BRIEF DESCRIPTION OF THE DRAWINGS

The above and other features of the present invention will be described in reference to certain exemplary embodiments thereof with reference to the attached drawings in which:

FIG. 1 shows an operation of a wheel feeder according to a conventional art;

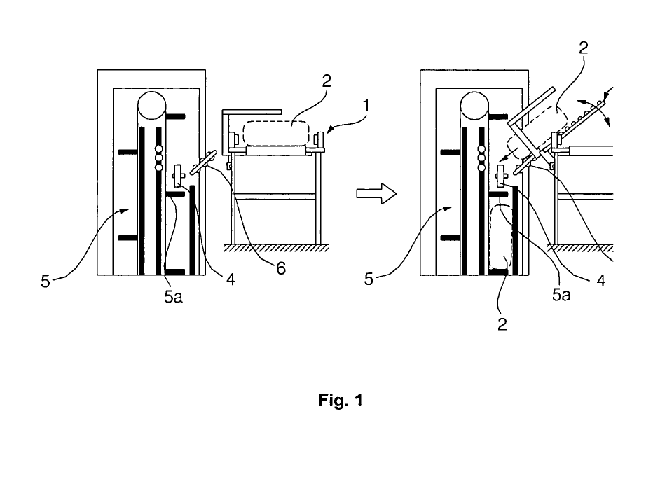

FIG. 2A shows a state that a wheel is rested on a seesaw stopper of a wheel feeder according to an exemplary embodiment of the present invention;

FIG. 2B shows a state that the wheel is rested on a stop arm of the wheel feeder according to the exemplary embodiment of the present invention; and

FIG. 2C shows a state that the wheel is rested on a wheel guide bard of the wheel feeder according to the exemplary embodiment of the present invention.

### DETAILED DESCRIPTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

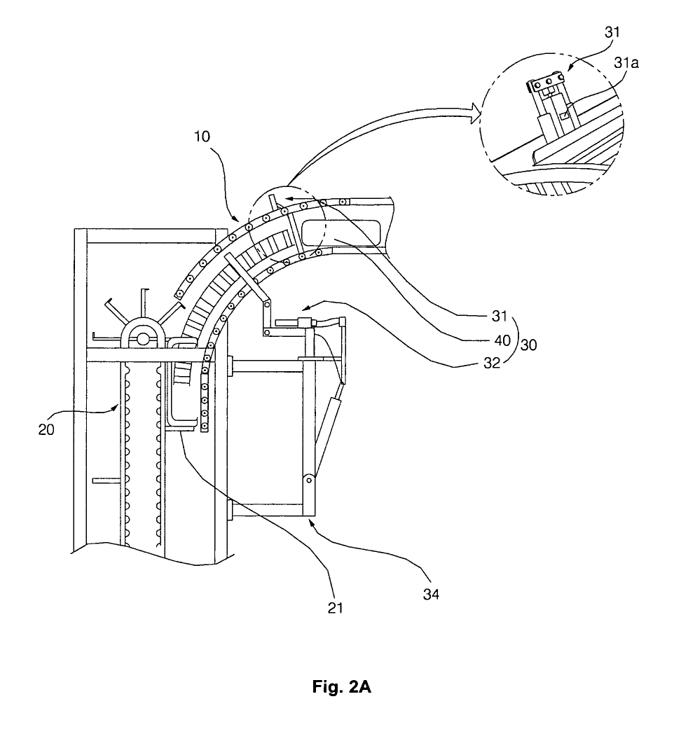

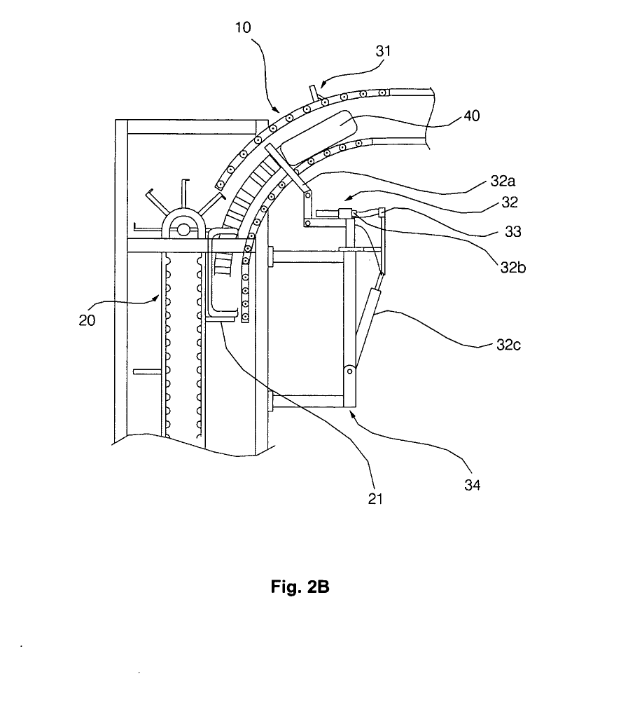

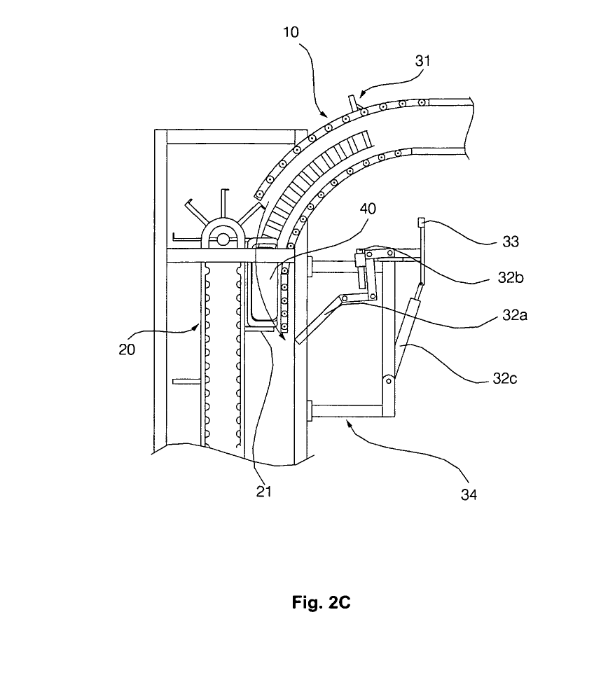

FIG. 2A shows a state that a wheel is rested on a seesaw stopper of a wheel feeder according to an exemplary embodiment of the present invention.

FIG. 2B shows a state that the wheel is rested on a stop arm of the wheel feeder according to the exemplary embodiment of the present invention. FIG. 2C shows a state that the wheel is rested on a wheel guide bard of the wheel feeder according to the exemplary embodiment of the present invention.

As shown in FIGS. 2A to 2C, the wheel feeder according to the exemplary embodiment of the present invention comprises a vertical lifter 10 for receiving a wheel 40 from the transferring conveyor, a vertical conveyor 20 for receiving the wheel 40 from the vertical lifter 10 and transferring the wheel 40 to the wheel mounting factor (not shown), and a wheel stopper unit 30 mounted to the vertical lifter 10 to supply the wheel 40 to the vertical conveyor 20 without damaging the wheel 40.

The wheel stopper unit 30 comprises a seesaw stopper 31 on which the wheel 40 transferred from the transferring conveyor is firstly rested on and a stop arm 32 on which the wheel 40 supplied from the seesaw stopper 31 is secondly rested. The seesaw stopper 31 comprises a sensor 31a for moving the seesaw stopper 31 in an upper direction of the vertical lifter 10 when the wheel is rested on the seesaw stopper, and the stop arm 32 comprises a resting portion 32a on which the wheel 40 supplied from the seesaw stopper 31 is rested, a link portion 32b which is hinge-coupled to the resting portion 32a to rotate the resting portion 32a in order to supply the wheel rested on the resting portion 32a onto the vertical conveyor 20, and a cylinder portion 32c for operating the link portion 32b.

A wheel guide bar 21 on which the wheel 40 supplied from the stop arm 32 is rested is formed in the vertical conveyor 20 in a direction crossing a longitudinal direction of the vertical conveyor 20. A rotation direction detecting sensor 33 which controls a speed of the stop arm 32 to rest the wheel 40 rested on the resting portion 32a of the stop arm 32 onto the wheel guide bar 21 at a low speed is mounted to the link portion 32b.

The cylinder portion 32c is supported by a bracket 34 installed in the vertical lifter 10, and one side of the link portion 32b may be hinge-coupled to the bracket 34.

An operation of the wheel feeder according to the exemplary embodiment of the present invention is described below.

When the wheel transferred from the transferring conveyor is supplied to the vertical lifter 10, the wheel 40 is rested on the seesaw stopper 31 installed on the vertical lifter 10, and when the sensor 31a mounted to the seesaw stopper 31 detects when the wheel 40 is rested on the seesaw stopper 31, the seesaw stopper 31 is raised in the upper direction of the vertical lifter 10, so that the wheel 40 is transferred to and rested on the resting portion 32a of the stop arm 32.

After the wheel 40 is rested on the resting portion 32a of the stop arm 32, a limit switch (not shown) connected with the rotation direction detecting sensor 33 is switched to a low speed down mode, and so the cylinder portion 32c of the stop arm 32 operates to rotate the resting portion 32a of the stop arm 32 through the link portion 32b, so that the wheel 40 is rested on the wheel guide bar 21 formed in the vertical conveyor 20.

When the wheel 40 is rested on the wheel guide bar 21, the wheel 40 is supplied to the wheel mounting factory (not shown) located below the vertical conveyor 20 by rotation of the vertical conveyor 20.

After the above described process is completed, the seesaw stopper 31 moves down to prepare for transferring the next wheel, and the stop arm 32 also returns to an original state by switching of the limit switch (not shown). Thereafter, the above described process is repeated.

As described above, the wheel feeder according to the present invention comprises the vertical lifter for receiving the wheel from the transferring conveyor, the vertical conveyor for receiving the wheel from the vertical lifter and transferring the wheel to the wheel mounting factor, and the wheel stopper unit mounted to the vertical lifter to supply the wheel to the vertical conveyor without damaging the wheel 40 and thus supplies the wheel to the wheel mounting factory without damaging the wheel.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A wheel feeder for supplying a wheel to a wheel mounting factory, comprising:
a vertical lifter for receiving a wheel transferred from a transferring conveyor;
a vertical conveyor for receiving the wheel from the vertical lifter and transferring the wheel to a wheel mounting factory; and
a wheel stopper unit mounted to the vertical lifter to supply the wheel to the vertical conveyor without damaging the wheel.

2. The wheel feeder of claim 1, wherein the wheel stopper unit comprises a seesaw stopper on which the wheel transferred from the transferring conveyor is firstly rested and a stop arm on which the wheel supplied from the seesaw stopper is secondly rested.

3. The wheel feeder of claim 2, wherein the seesaw stopper is provided with a sensor for detecting position of the transferred wheel such that when the wheel is detected to be rested on the seesaw stopper, the seesaw stopper can be moved in an upper direction of the vertical lifter.

4. The wheel feeder of claim 2, wherein the stop arm comprises a resting portion on which the wheel supplied from the seesaw stopper is rested, a link portion which is hinge-coupled to the resting portion to rotate the resting portion in order to supply the wheel rested on the resting portion onto the vertical conveyor, and a cylinder portion for operating the link portion.

5. The wheel feeder of claim 4, wherein the link portion is provided with a sensor for detecting rotation direction of the wheel such that when the rotation direction is detected to be in a predetermined range, the speed of the stop arm can be reduced for the wheel rested on the resting portion of the stop arm to be rested onto the wheel guide bar at a low speed.

6. The wheel feeder of claim 4, wherein the cylinder portion is supported by a bracket installed in the vertical lifter.

7. The wheel feeder of claim 6, wherein one side of the link portion is hinge-coupled to the bracket.

8. The wheel feeder of claim 2, wherein a wheel guide bar on which the wheel supplied from the stop arm is rested is formed in the vertical conveyor in a direction crossing a longitudinal direction of the vertical conveyor.

9. The wheel feeder of claim 8, wherein the link portion is provided with a sensor for detecting rotation direction of the wheel such that when the rotation direction is detected to be in a predetermined range, the speed of the stop arm can be reduced for the wheel rested on the resting portion of the stop arm to be rested onto the wheel guide bar at a low speed.
